(19) United States
(12) Patent Application Publication
(10) Pub. No.: US 2004/0204037 A1
(43) Pub. Date: Oct. 14, 2004

(54) RF front-end for dual-band wireless transceiver module

(76) Inventors: Ziming He, Irvine, CA (US); Ping Peng, Irvine, CA (US); Nopakorn Hiranrat, Walnut, CA (US); Yin Qian, Hacienda Heights, CA (US); Fusheng Chen, Bellflower, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/318,249

(22) Filed: Dec. 11, 2002

Related U.S. Application Data
(63) Continuation-in-part of application No. 10/226,006, filed on Aug. 21, 2002.

(51) Int. Cl. H04B 1/38

(52) U.S. Cl. 455/553.1; 455/552.1

(57) ABSTRACT

A radio frequency (RF) front-end (30) employed in a dual-mode transceiver module connects a first and a second dual-band antennas (40a, 40b), and includes a first and a second signal receiving paths for receiving RF signals in two different frequency bands, a first and second signal transmitting paths for transmitting RF signals in the two different frequency bands, and a switch unit connecting the first and second dual-band antennas with the first and second signal transmitting and receiving paths. The switch unit includes a double pole double throw (DPDT) switch (31) and two single pole double throw (DPDT) switches (32, 33). The switch unit performs an antenna selection function for both the first and second transmitting paths and the first and second receiving paths.

### CROSS-REFERENCE TO RELATED APPLICATIONS

This application is a continuation-in-part (CIP) of a co-pending U.S. patent application entitled “RF FRONT-END FOR DUAL-MODE WIRELESS LAN MODULE”, having Ser. No. 10/226,006, filed on Aug. 21, 2002, which relates to another co-pending U.S. patent application entitled “RF FRONT-END OF DUAL-MODE WIRELESS LAN MODULE”, having Ser. No. 10/225,808, filed on Aug. 21, 2002.

### BACKGROUND OF THE INVENTION

1. Field of the Invention

The present invention relates to a radio frequency (RF) front-end design, and more particularly to an RF front-end employed in a dual-band wireless transceiver module.

2. Description of the Prior Art and the Related Art

There are an increasing number of dual-mode wireless communication products becoming available on the market today, e.g. dual-mode cellular phones, dual-mode Wireless Local Area Network (WLAN) cards and Access Points (AP).

RF front-end design is the key and most difficult part in a dual-mode wireless transceiver module design. One problem in RF front-end design is how to design an antenna selection diversity function. Generally, since transmitted signals are much stronger than received signals, antenna selection diversity for receiver is more important than for transmitter. Thus, most designs only have antenna selection diversity for receiver, and there is no antenna diversity for transmitter. Antenna diversity for receiver allows the wireless transceiver module to select an antenna with better performance for the received signals. Since transmitter does not have antenna diversity, there is small insertion loss in the transmitting path. However, such designs usually connect the transmitter path to the antenna directly and results in impedance match difficulty.

Due to the influence of the operating environment, an antenna diversity function in the transmitting path can help improve the quality of the transmitted signals. However, adding the antenna diversity function for transmitter would require adding more control components, which will increase insertion losses in the transmitting path.

Hence, an RF front-end with antenna diversity for both transmitter and receiver and less insertion loss on both transmitter and receiver paths for a dual-mode wireless communication module is desired for overcoming the above mentioned disadvantages.

### BRIEF SUMMARY OF THE INVENTION

A main object of the present invention is to provide a radio frequency (RF) front-end for a dual-mode wireless transceiver module.

Another object is to provide a dual-mode RF front-end with antenna selection diversity for both the transmitting path and the receiving path.

An RF front-end according to an embodiment of the present invention, which is employed in a dual-mode transceiver module, includes a first and second dual-band antennas, a first and second signal receiving paths for receiving RF signals in two different frequency bands, a first and second signals transmitting paths for transmitting RF signals in the same two different frequency bands, and a switch unit connecting the first and second dual-band antennas with the first and second signal transmitting and receiving paths. The switch unit includes a double pole double throw (DPDT) switch and two single pole double throw (SPDT) switches, and performs an antenna selection function for both the first and second transmitting paths and the first and second receiving paths.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a dual-mode Wireless Local Area Network (WLAN) module including an RF front-end according to the present invention.

FIG. 2 is a schematic diagram showing an example of an implementation of the switch portions of the RF front-end of FIG. 1.

### DETAILED DESCRIPTION OF THE INVENTION

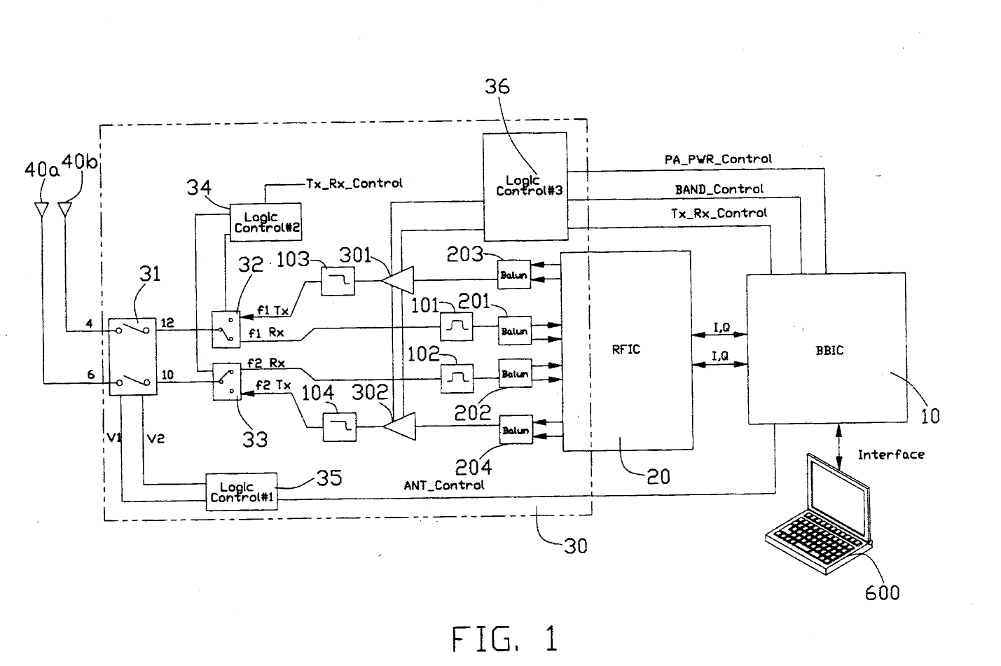

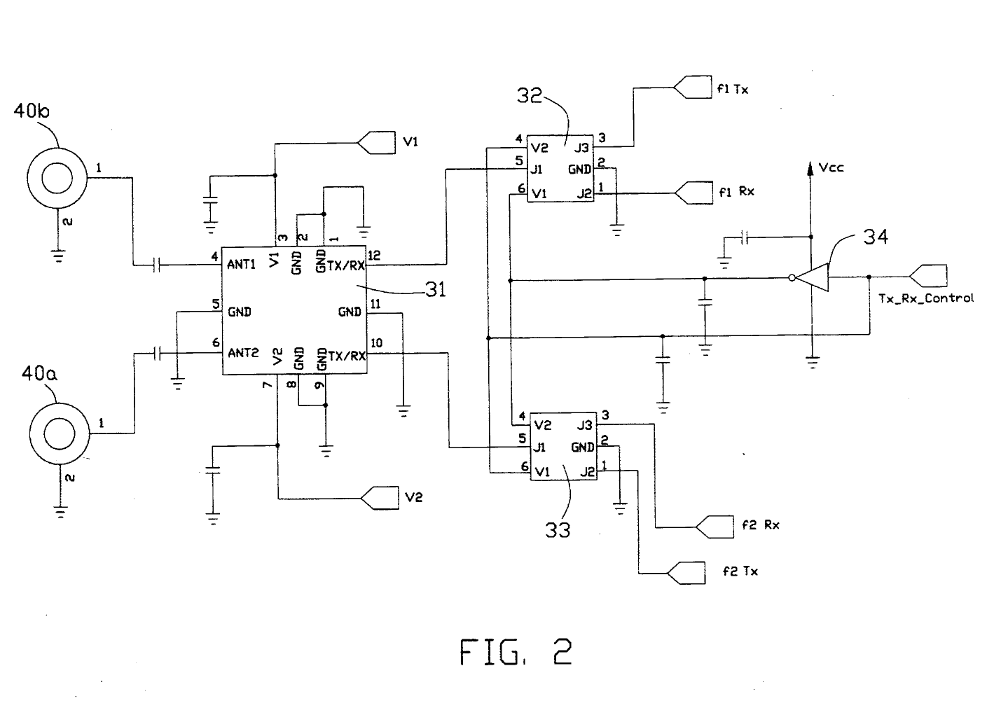

Referring to FIGS. 1 and 2, a 802.11a/b dual-mode Wireless Local Area Network (WLAN) module comprises two main parts: a radio frequency (RF) part and a Base-Band part. The RF part includes two dual-band antennas 40a, 40b, an RF front-end 30 and an RF integrated circuit (IC) 20. The Base-Band part includes a Base-Band (BB) IC 10 and an interface circuit (not labeled) to the RFIC 20. The Base-Band part further includes an interface (not shown) to electrically connect with a laptop computer 600.

The coupling between the RFIC 20 and the BBIC 10 can be conveniently achieved based on a known combined 802.11a/b chipset solution, and the coupling between the BBIC 10 and the interface is known to one skilled in the art, so detailed descriptions of these couplings are omitted herein.

The dual-band antennas 40a, 40b operate in the 2.4 to 2.4835 GHz frequency band and in the 5.15 to 5.825 GHz frequency band. The RFIC 20 receives signals from and transmits signals to the dual-band antennas 40a, 40b via the RF front-end 30.

The RF front-end 30 includes three switches 31-33, four filters 101-104, four baluns 201-204, two power amplifiers (PA) 301, 302, and three logic control units 34-36. The three switches 31-33 control the dual-band antennas' 40a, 40b diversity and transmit/receive functions. The three logic control units 34-36 control the ON/OFF states of the three switches 31-33 and the PAs 301, 302.

The switch 31 is a double pole double throw (DPDT) switch and comprises pins 4, 6, which respectively connect to the two dual-band antennas 40b, 40a, and pins 12, 10, which respectively connect to the switches 32, 33. The switches 32, 33 are single pole double throw (SPDT) switches. The switch 32 connects the pin 12 of the switch 31 selectively with a first frequency band signal transmitting path, which comprises the balun 203, the PA 301 and the filter 103, or with a first frequency band signal receiving path which comprises the balun 201 and the filter 101. The switch 33 connects the pin 10 of the switch 31 selectively with a second frequency band signal transmitting path, which comprises the balun 204, the PA 302 and the filter 104, or with a second frequency band signal receiving path which comprises the balun 202 and the filter 102. The first frequency band can be, for instance, the 2.4-2.4835 GHz band, and the second frequency band the 5.15-5.825 GHz band, or visa versa. The filters 101, 102 are band pass filters (BPF) and the filters 103, 104 are low pass filters (LPF).

Signals received from the dual-band antennas 40a, 40b comprise signal f1 Rx (2.4-2.4835 GHz) and signal f2 Rx (5.15-5.825 GHz), which are selected by the combination of switches 31-33. The signal f1 Rx is filtered by the BPF 101, and the filtered signal f1 Rx is transferred into the RFIC 20 via the balun 201. Similarly, the signal f2 Rx is filtered by the BPF 102, and the filtered signal f2 Rx is transferred into the RFIC 20 via the balun 202.

Signals sent to the dual-band antennas 40a, 40b for transmission comprise a signal f1 Tx (2.4-2.4835 GHz) and a signal f2 Tx (5.15-5.825 GHz), which are generated by the RFIC 20. The signal f1 Tx is sent to the PA 301 via the balun 203. The signal f1 Tx, after it has been amplified by the PA 301, is filtered by the LPF 103, and the filtered signal f1 Tx is routed to the dual-band antennas 40a, 40b through the switches 31, 32. Similarly, the signal f2 Tx is first sent to the PA 302 via the balun 204. The signal f2 Tx, after it has been amplified by the PA 302, is filtered by the LPF 104, and the filtered signal f2 Tx is routed to the dual-band antennas 40a, 40b through the switches 31, 33.

The #1 logic control unit 35 is controlled by an antenna diversity control signal (ANT_Control) from the BBIC 10 and outputs signals V1 and V2 to control the switch 31. When the voltage level of the signal V1 is low and the voltage level of the signal V2 is high, the pins 4, 12 are connected and the pins 6, 10 are connected; when the voltage level of the signal V1 is high and the voltage level of the signal V2 is low, the pins 4, 10 are connected and the pins 6, 12 are connected. Therefore, the antenna selection function of the RF front-end 30 is achieved by the switch 31 and the #1 logic control unit 35.

The #2 logic control unit 34 is controlled by a transmitting/receiving control signal (Tx_Rx_Control) from the BBIC 10 and controls the switches 32, 33 to connect the transmitting paths or the receiving paths. When the transmitting paths are ON, the receiving paths are OFF; when the receiving paths are ON, the transmitting paths are OFF. By ensuring that only the transmitting paths or the receiving paths are connected at one time, good isolation between the transmitting paths and the receiving paths is ensured.

The #3 logic control unit 36 controls the two PAs 301, 302 and is itself controlled by a combination of signals, which include a PA power control signal (PA_PWR_Control), a frequency band control signal (BAND_Control) and the Tx_Rx_Control signal from the BBIC 10. When the PA 301 is ON, the PA 302 is OFF; when the PA 302 is ON, the PA 301 is OFF. Only one PA is enabled at a time so that when one transmitting path is selected, the associated PA is enabled to transmit signals, and the PA in the second transmitting path will be disabled.

When the 802.11a/b dual-mode WLAN module transmits signals, the switches 32, 33 connect the transmitting paths under the control of the Tx_Rx_Control signal, and the #3 logic control unit 36 selects which PA 301, 302 is turned ON to enable the corresponding transmitting path.

When the 802.11a/b dual-mode WLAN module receives signals, the switches 32, 33 connect the receiving paths under the control of the Tx_Rx_Control signal.

The 802.11a/b dual-mode WLAN module is mounted into the laptop computer 600 and the two dual-band antennas 40a, 40b are located in different locations in the laptop computer 600. Thus, the two dual-band antennas 40a, 40b have different receiving/transmitting performances for incoming/outgoing signals. The ANT_Control signal controls the switch 31 to select a dual-band antenna 40a, 40b that has the better receiving/transmitting performance.

Using this design of an antenna selection function, either the receiving paths or the transmitting paths will be enabled at a given time. Thus, the receiving paths will be well isolated from the transmitting paths. Additionally, since only two-switch control stage is used on each transmitting or receiving path, lower insert losses are achieved in the transmitting or receiving paths.

This design can be used not only in the design of RF front-ends for 802.11a/b dual-mode WLAN modules, but can also be used in the design of any other dual-band wireless transceiver module for wireless communication devices, such as cellular phones.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A radio frequency (RF) front-end adapted to be employed in a dual-mode transceiver module, wherein the dual-mode transceiver module has first and second dual-band antennas, first and second signal transmitting paths and first and second signal receiving paths, comprising:
a double pole double throw (DPDT) switch having first and second output pins respectively coupling to the first and the second dual-band antennas, and first and second input pins;
a first single pole double throw (SPDT) switch coupling the second input pin with the first signal transmitting and receiving paths of the dual-mode transceiver module; and
a second SPDT switch coupling the first input pin with the second signal transmitting and receiving paths of the dual-mode transceiver module.

2. The RF front-end as claimed in claim 1, further comprising a first logic control unit to control the DPDT switch to select either the first output and input pins being connected and the second output and input pins being connected, or the first output pin and the second input pin being connected and the second output pin and the first input pin being connected.

3. The RF front-end as claimed in claim 2, further comprising a second logic control unit to control the first and second SPDT switches to enable either the first and second signal transmitting paths or the first and second signal receiving paths.

4. An RF front-end adapted to be employed in a dual-mode transceiver module, comprising:
first and second antennas;
first and second signal receiving paths for receiving RF signals in two different frequency bands;
first and second signal transmitting paths for transmitting RF signals in the two different frequency bands; and
a switch unit connecting the first and second antennas with the first and second signal transmitting and receiving paths, and performing an antenna selection function in both the first and second transmitting paths and the first and second receiving paths.

5. The RF front-end as claimed in claim 4, wherein the switch unit comprises a DPDT switch coupling to the first and second antennas, a first SPDT switch connecting the DPDT switch with the first signal transmitting and receiving paths, and a second SPDT switch connecting the DPDT switch with the second signal transmitting and receiving paths.

6. The RF front-end as claimed in claim 4, wherein the first and second signal transmitting paths respectively comprises a first and second power amplifiers (PA).

7. The RF front-end as claimed in claim 6, further comprising a logic control unit to enable either the first PA or the second PA 8. A radio frequency (RF) front-end adapted to be employed in a dual-mode transceiver module, wherein the dual-mode transceiver module has first and second dual-band antennas, first and second signal transmitting paths and first and second signal receiving paths, comprising:
a first switch having first and second output pins respectively coupling to the first and the second dual-band antennas, and first and second input pins;
a second switch coupling the second input pin with the first signal transmitting and receiving paths of the dual-mode transceiver module;
a third switch coupling the first input pin with the second signal transmitting and receiving paths of the dual-mode transceiver module;
a first power amplifier connected to the first transmitting path; and
a second power amplifier connected to the second transmitting path; wherein
the transmitting paths and the receiving paths are mutually exclusive enabled, and the first power amplifier and the second power amplifier are mutually exclusively enabled.
